(19) United States
(12) Patent Application Publication
(10) Pub. No.: US 2009/0284160 A1
(43) Pub. Date: Nov. 19, 2009

(54) CURRENT BALANCING CIRCUIT

(75) Inventors: Arnold Willem Buij, Eindhoven (NL); Alexander Abraham Cornelius Van Der Zande, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/307,772

(22) PCT Filed: Jul. 4, 2007
(86) PCT No.: PCT/IB07/52622

§ 371 Date: Jan. 7, 2009

(30) Foreign Application Priority Data
Jul. 7, 2006 (EP) 06116824.1

(51) Int. Cl. H05B 41/14

(52) U.S. Cl. 315/189; 315/254

(57) ABSTRACT

The invention provides a current balancing circuit for powering a first load with a negative dynamic resistance and a second load with an essentially different negative dynamic resistance, and a transformer with such turns ratio that at least at an operating frequency impedances of the first and second windings complement the resistances of the first and the second loads, respectively, to a common value.

### FIELD OF THE INVENTION

The invention relates in general to a current balancing circuit. In particular, the invention relates to a current balancing circuit comprising a transformer. More specifically, the invention relates to a current balancing circuit for loads with a negative dynamic resistance, such as fluorescent lamps.

### BACKGROUND OF THE INVENTION

Current balancing transformers, also referred to as equalizers, are used in electrical circuits wherein multiple loads connected in parallel are powered by a single power supply, when equal currents in the loads are desired. Such circuits e.g. may be applied for powering multiple fluorescent lamps, such as for providing a backlight for LCD displays. Here it is desired to power all lamps with equal currents, in order to obtain equal light intensities. U.S. Pat. No. 4,574,222 discloses a circuit, in which in series with each load, a winding of a common transformer, magnetically coupled with other windings of said common transformer is connected. Small differences in the currents through the loads, caused by differences in the electrical properties of the loads, are then counteracted by a voltage induced in the winding connected in series with the load. For obtaining equal currents through essentially equal loads, the transformer windings need to have an equal number of turns.

For circuits with a plurality of loads, it is also known in the art to connect a primary winding of an individual transformer in series with each load, wherein each transformer is equal to another one, and to form a short circuit comprising the secondary windings of all individual transformers. Such a circuit forces the currents in all loads to be equal.

However, the circuits known in the art have the disadvantage that they are merely capable of compensating small differences in the electric properties of the loads, such as parasitic differences. When the differences between the loads are large, compensation is only possible by increasing the self-inductance of the windings in series with the loads, which may lead to unacceptably large and expensive transformers, or an increase in inductive circuit components to be coupled in series with.

### OBJECT OF THE INVENTION

It is an object of the present invention to provide a current balancing circuit, which is capable to control currents through unequal loads with negative dynamic resistances, which are powered by a common source, without the above mentioned disadvantages.

### SUMMARY OF THE INVENTION

In an aspect, the invention provides a load feed circuit. The circuit comprises a first load with a negative dynamic resistance a second load with a negative dynamic resistance. The negative dynamic resistance of the first load to be powered can be essentially different from the negative dynamic resistance of the second load to be powered, for example because the first load comprises a fluorescent lamp, while the second load comprises a series connection of two fluorescent lamps, both identical to the lamp of the first load. In that case, the negative dynamic resistances of the first load and second load differ by a factor two. The circuit further comprises a transformer with a first winding connected in series with the first load and a second winding connected in series with the second load, the windings being coupled magnetically by a core of the transformer. Herein, the turns ratio of the transformer is selected such that at least in operation at an operating frequency an unbalance between the currents through the loads is compensated. In an application wherein the loads are backlight lamps for a LCD display, a balance between the load currents implies a desired, essentially equal light intensity delivered by all powered lamps. The invention will be explained below with reference to the accompanying drawings.

### BRIEF DESCRIPTION OF THE DRAWINGS

FIG. 1 shows a current balancing circuit according to the state of the art.

FIG. 2 shows a current balancing circuit according to the present invention.

### DETAILED DESCRIPTION OF EXAMPLES

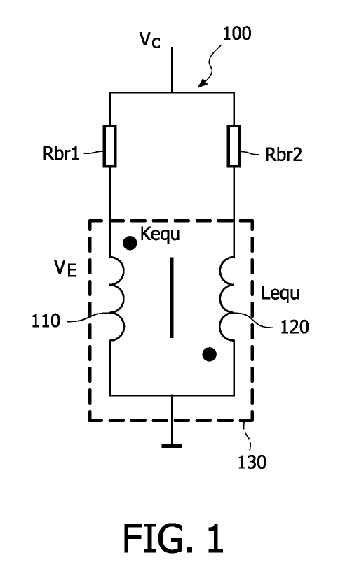

FIG. 1 shows a current balancing circuit 100 according to the state of the art. The circuit 100 comprises a first load Rbr1 and a second load Rbr2, connected in parallel to a power source supplying voltage V_{C}. The loads Rbr1 and Rbr2 have essentially equal values, but parasitic differences may be present. Loads Rbr1 and Rbr2 have negative dynamic resistances, meaning that at some point along their voltage-current-characteristic, an increase of the current through the lamp leads to a decrease of the voltage across the lamp. In series with Rbr1 a winding 110 of transformer 130, with coupling factor Kequ, having a value about 1, and open self-inductance Lequ, is connected, and in series with Rbr2 a winding 120 of transformer 130 is present. Windings 110 and 120 have the same number of turns. The transformer is used to overcome inherent instability of two loads with negative dynamic resistance, by inducing a voltage V_{E} that counteracts a difference in the currents through Rbr1 and Rbr2. However, when the resistances Rbr1 and Rbr2 are essentially unequal, it becomes more difficult to guarantee equal currents. When the circuit is used with a power or current-regulated lamp driver, there is no easy way to prevent a high inductance value in case of unequal loads, unless the transformer inductance is chosen to be relatively high, which is undesirable, since it increases the costs of the design.

As a numerical example a first resistance can be a fluorescent lamp with a resistance value of 1333 Ohm, and a second resistance can be a series connection of two fluorescent lamps, having a common resistance of 2667 Ohm. As a rule of thumb, the open self-inductance of the transformer is chosen to be about 5 times higher than the average load. In this case a value of Lequ of 3.18 mH would be required at an operating frequency of 100 kHz, resulting in an unbalance of 12%. To reduce the unbalance to less than 1%, the required value increases up to 15 mH, which is unacceptably high for reasons of design and production costs.

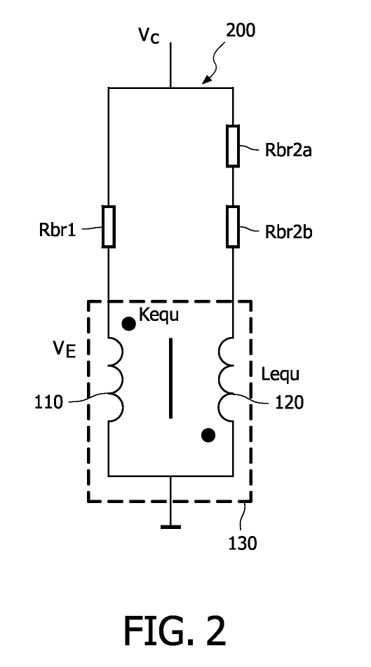

FIG. 2 shows a circuit according to the present invention. The circuit 200 comprises a first load formed by negative dynamic resistance Rbr1 and second load formed by negative dynamic resistances Rbr2a and Rbr2b, the first load and second load being connected in parallel to a power source supplying voltage V_{C}. The loads Rbr1 and Rbr2a and Rbr2b all have essentially equal values, so Rbr2a and Rbr2b have a summated resistance that is about twice the value of Rbr1. In series with Rbr1 a winding 110 of transformer 130, with coupling factor Kequ having a value of about 1, and open self-inductance Lequ is connected, and in series with Rbr2a and Rbr2b a winding 110 of transformer 130 is present. The transformer is used to overcome inherent instability of two loads with negative dynamic resistance, by inducing a voltage V_{E} in winding 110 that counteracts a difference in the currents through Rbr1 and Rbr2.

According to the invention, the transformer does not have a high self inductance Lequ, but instead it possesses a difference in the number of windings in order to compensate for the difference in resistance between the first load and the second load. Herein, the winding having the lowest self-inductance, is connected in series with the load having the largest load negative dynamic resistance. For the values mentioned in the above example, a first resistance of 1333 Ohm and a second resistance of 2667 Ohm, a value of 3.7 mH for the first winding, and a value of 2.7 mH for the second winding reduce the unbalance to 1%. These values can be realized with a transformer with a turns ratio of the first and second winding of 1.17:1. In general, it is desired to have windings with a relatively low inductance, and turns ratios that differ only slightly from of 1:1, for reasons of design and production costs. Herein, the winding 120 with the lowest self-inductance is connected in series with the load having the largest load negative dynamic resistance, i.e. the second load formed by Rbr2a and Rbr2b.

For those cases wherein the second load has a resistance that is between half the value of the first load and twice the value of the first load, two rules of thumb can be given: one for selecting the values of the impedances of the first and second windings, and one for selecting their difference. The first rule of thumb is that the average value of the impedances of the first winding 110 and second winding 120 can be selected equal to the average value of the load resistances Rbr1 and Rbr2a+Rbr2b. At a switching frequency of e.g. 100 kHz, the impedances of the first winding 110 and second winding 120 with self-inductances of 3.7 mH and 2.7 mH, respectively, are 2325 Ohms and 1700 Ohms. The average value thereof essentially equals the average value of the load resistances Rbr1 (of 1333 Ohm) and Rbr2a+Rbr2b (of 2667 Ohm). The second rule of thumb is that the difference between the inductances of the first winding 110 and the second winding 120 can be selected such that said difference divided by the average inductance of the windings 110 and 120 equals half the value of the difference between the load resistances, divided by the average value of the load resistances.

In a practical application, such as a dimming backlight for LCD-TV applications, frequencies of about 20 kHz to about 500 kHz are used to power the lamps. According to the present invention, dimming is performed by pulse width modulation on the powering current. For example pulse width modulated pulses with a repetition frequency of between about 45 and about 500 Hz are used to switch a signal of for example about 100 kHz. By keeping high frequency and it's RMS value constant, the impedance of the windings has a fixed value, and the lamp current can be controlled accurately. In this way, also the light intensity of each lamp can be controlled.

As required, a detailed embodiment of the present invention is disclosed herein; however, it is to be understood that the disclosed embodiment is merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. The terms “a” or “an”, as used herein, are defined as one or more than one.

1. Load feed circuit comprising:
a first load with a first negative dynamic resistance;
a second load with a second negative dynamic resistance, the second load essentially different from the first load;
a transformer comprising a first transformer winding and a second transformer winding coupled magnetically, the first transformer winding being connected in series with the first load, and the second transformer winding being connected in series with the second load;
wherein:
the numbers of turns of the first transformer winding and the second transformer winding are selected with such a difference that at least in operation at a predetermined operating frequency an unbalance between the current through the first transformer winding and the current through the second transformer winding is compensated for.

2. Circuit according to claim 1, wherein the first load comprises a fluorescent lamp.

3. Circuit according to claim 2, wherein the second load comprises a series connection of a number of fluorescent lamps different from a number of fluorescent lamps of the first load.

4. Circuit according to claim 1, wherein a transformer winding connected in series with the load having the largest load negative dynamic resistance is selected to have the lowest number of turns.

5. Circuit according to claim 1, wherein the first and the second loads are powered at an operating frequency between 20 kHz and 500 kHz.

6. Circuit according to claim 1, wherein a load current is pulse width modulated.

7. Circuit according to claim 6, wherein the pulse width modulation has a pulse frequency between 45 and 500 Hz.

8. Circuit according to claim 1, wherein a coupling factor of the transformer is about 1.

9. Circuit according to claim 1, wherein the transformer has a low self-inductance.

10. Circuit according to claim 1, wherein an impedance of the first winding and an impedance of the second winding are selected to have an average value that equals an average value of a resistance of the first load and a resistance of the second load.

11. Circuit according to claim 1, wherein a difference between an inductance of the first winding and an inductance of the second winding are selected such that said difference divided by the average of an inductance of the first winding and an inductance of the second winding equals half the value of the difference between a resistance of the first load and a resistance of the second load, divided by the average value of the resistance of the first load and the resistance of the second load.

12. Transformer configured for use in a circuit according to claim 1.

13. LCD display device, comprising a load feed circuit according to claim 1.

14. LCD display device according to claim 13, wherein the first load and the second load each comprise at least one fluorescent lamp for backlighting the display.

15. Method for balancing a current in a load feed circuit, comprising the steps of:
providing a first load with a first negative dynamic resistance;
providing a second load with a second negative dynamic resistance;
providing a transformer having a first transformer winding and a second transformer winding magnetically coupled to each other;
connecting the first transformer winding in series with the first load;
connecting the second transformer winding in series with the second load;
selecting the turns ratio of the transformer such that at least in operation at a predetermined operating frequency an unbalance between the current through the first transformer winding and the current through the second transformer winding is compensated for.
